(19) United States
(12) Patent Application Publication
(10) Pub. No.: US 2020/0367490 A1
(43) Pub. Date: Nov. 26, 2020

(54) CONTROLLED RELEASE BIODEGRADABLE COATINGS FOR SEEDS AND FERTILIZERS

(71) Applicant: Danimer Bioplastics, Inc., Bainbridge, GA (US)

(72) Inventors: Phillip Van Trump, Decatur, GA (US); Joe B. Grubbs, III, Bishop, GA (US); Adam Johnson, Bainbridge, GA (US)

(73) Assignee: Danimer Bioplastics, Inc., Bainbridge, GA (US)

(21) Appl. No.: 16/880,106

(22) Filed: May 21, 2020

Related U.S. Application Data
(60) Provisional application No. 62/852,440, filed on May 24, 2019.

(51) Int. Cl. A01N 25/26; C05G 5/30

(52) U.S. Cl. CPC A01N 25/26; C05G 5/37

(57) ABSTRACT

A granular composition for agricultural coatings is disclosed. The granular composition is made up of a plurality of granulates having at least one biodegradable coating applied over the granulates. The granulates are selected from the group consisting of seeds, fertilizers, and pesticides. The biodegradable coating is made up of polyhydroxyalkanoates, such as monomer residues of 3-hydroxybutyrate and monomer residues of 3-hydroxyhexanoate. A method for making the coated granular composition and a method for controlled release of the granular material in the field are also disclosed.

### FIELD

This disclosure relates to biodegradable polymeric compositions. More particularly, this disclosure relates to controlled release biodegradable coatings for seeds and fertilizers.

### BACKGROUND

Plants uptake nutrients at various rates based on environmental conditions, but the most critical time for nutrient uptake is during the plant's early development, where the nutrients must be plentiful during this time. However, excess nitrogen uptake may over-stimulate vegetative growth and delay crop maturity. Thus, the timing of nutrient uptake is crucial to maximize crop yields.

To address these issues, controlled release fertilizers (CRFs) have been produced, wherein fertilizers are encapsulated by a petroleum polymer coating that slowly releases the fertilizer into the soil. Thus, nutrients may be delivered at a pace more compatible with the plant's metabolic needs. Changes in temperature, humidity, or bioactivity of the soil, however, can unpredictably alter this rate, resulting in negative effects on crop yields by providing the incorrect amount of nutrients at the incorrect time. Thus far, the commercial application of CRFs is limited due to the lack of data about the release kinetics in different environmental conditions. Furthermore, the petroleum-based coating applied to the fertilizer is not environmentally friendly and may persist in the environment for years after the application of the fertilizer.

Thus, it would be desirable to provide a new controlled release fertilizer formulation having a coating which is non-harmful to the environment and which does not persist past the growing season. It would also be desirable to provide a new controlled release fertilizer formulation having a more predictable and controllable fertilizer release rate.

### SUMMARY OF THE INVENTION

The above and other needs are met by a granular composition for agricultural use in accordance with the current disclosure. According to one embodiment, this granular composition is made up of a plurality of granulates having a first biodegradable coating layer applied over the granulates. These granulates in turn are made up of a material selected from the group consisting of seeds, fertilizers, and pesticides. The first biodegradable coating is made up of polyhydroxyalkanoates, and these polyhydroxyalkanoates include from about 70 to about 99 mole percent monomer residues of hydroxybutyrates and from about 1 to about 30 mole percent monomer residues of a different hydroxyalkanoate having from 5 to 22 carbon atoms.

In some instances, the polyhydroxyalkanoates are preferably made up of from about 70 to about 99 mole percent monomer residues of 3-hydroxybutyrate. Also, in some instances, the polyhydroxyalkanoates are preferably made up of from about 1 to about 30 mole percent monomer residues of 3-hydroxyhexanoate.

In certain embodiments, the granulates of the composition are preferably made up of seeds. In other embodiments, the granulates of the composition are preferably made up of fertilizer, more preferably a urea-based fertilizer. In still further embodiments, the granulates of the composition are preferably made up of a pesticide.

In certain embodiments, the first biodegradable coating layer preferably includes polyhydroxyalkanoates having a weight average molecular weight from about 50,000 to about 2.5 million Daltons.

In certain embodiments, the granulates preferably have an average particle size, before coating, from about 1 mm to about 25 mm.

In certain embodiments, the polyhydroxyalkanoates may also include monomer residues of 3-hydroxyvalerate, 4-hydroxyvalerate, and/or 5-hydroxyvalerate.

Moreover, in some instances, the polyhydroxyalkanoates are preferably made up of three or more different types of hydroxyalkanoate monomer residues, each having from 5 to 22 carbon atoms.

In certain embodiments, the first biodegradable coating layer also includes at least one polymer selected from the group consisting of polycaprolactone, polylactic acid, polybutylene succinate, polybutylene succinate-co-adipate, polyvinyl alcohol, polyvinyl acetate, cellulose esters, polysaccharides, polybutylene adipate co butylene terephthalate, polyglycolic acid, polymaleic acid, and mixtures thereof.

In certain embodiments, the first biodegradable coating layer also includes from about 5 to about 95 weight percent polycaprolactone.

In a preferred embodiment, the first biodegradable coating layer is made up of less than one weight percent polyurethane. More preferably, the first biodegradable coating layer includes no polyurethane at all.

In certain embodiments, the first biodegradable coating layer is made up of about 50 to about 95 weight percent polyhydroxyalkanoates and about 5 to about 50 weight percent of a biodegradable polymer other than polyhydroxyalkanoates.

Further, at least the first biodegradable coating layer starts to dissolve after about 3 to about 21 days exposure to environmental conditions at a temperature of about −5 to about 60° C. and a pH of about 2 to 9. More preferably, at least 10 weight percent of the first biodegradable coating layer is dissolved after about 3 to about 21 days exposure to environmental conditions at a temperature of about 60 to about 100° F. (about 16 to about 38° C.).

In certain embodiments, the granular composition may also include a second biodegradable coating layer applied over the first biodegradable coating layer. This second biodegradable coating layer is preferably made up of at least polymer selected from the group consisting of polycaprolactone, polylactic acid, polybutylene succinate, polybutylene succinate-co-adipate, mesolactide, and polybutylene adipate-co-terephthalate, polyvinyl alcohol, polyvinyl acetate, cellulose esters, polysaccharides, polyglycolic acid, polymaleic acid, and mixtures thereof.

In a further aspect, the present disclosure provides a method for controlled release of a granular material. According to one embodiment, the method includes an initial step of providing a granular composition made up of a plurality of granulates having a first biodegradable coating layer applied over the granulates. These granulates in turn are made up of a material selected from the group consisting of seeds, fertilizers, and pesticides. The biodegradable coating is made up of polyhydroxyalkanoates, and theses polyhydroxyalkanoates include from about 70 to about 99 mole percent monomer residues of hydroxybutyrates and from about 1 to about 30 mole percent monomer residues of a different hydroxyalkanoate having from 5 to 22 carbon atoms.

In a second step, the granular composition is dispersed over a plot of soil.

At least the polyhydroxyalkanoates in the first biodegradable coating layer is then dissolved by exposing the plot of soil, and the granular composition dispersed therein, to moisture. Dissolution of the polyhydroxyalkanoates releases the granulate material into the soil.

In some instances, the polyhydroxyalkanoates are preferably made up of from about 70 to about 99 mole percent monomer residues of 3-hydroxybutyrate. Also, in some instances, the polyhydroxyalkanoates are preferably made up of from about 1 to about 30 mole percent monomer residues of 3-hydroxyhexanoate.

In certain embodiments of the method, the granulates of the composition are preferably made up of seeds. In other embodiments of the method, the granulates of the composition are preferably made up of fertilizer, more preferably a urea-based fertilizer. In still further embodiments, the granulates of the composition are preferably made up of a pesticide.

In certain embodiments of the method, the polyhydroxyalkanoates may also include monomer residues of 3-hydroxyvalerate, 4-hydroxyvalerate, and/or 5-hydroxyvalerate.

Moreover, in some instances, the polyhydroxyalkanoates are preferably made up of three or more different types of hydroxyalkanoate monomer residues, each having from 5 to 22 carbon atoms.

In certain embodiments of the method, the first biodegradable coating layer also includes at least polymer selected from the group consisting of polycaprolactone, polylactic acid, polybutylene succinate, polybutylene succinate-co-adipate, polyvinyl alcohol, polyvinyl acetate, cellulose esters, polysaccharides, polybutylene adipate co butylene terephthalate, polyglycolic acid, polymaleic acid, and mixtures thereof.

In certain embodiments of the method, the first biodegradable coating layer also from about 5 to about 95 weight percent polycaprolactone.

In a preferred embodiment of the method, the first biodegradable coating layer comprises less than one weight percent polyurethane. More preferably, the first biodegradable coating layer includes no polyurethane at all.

In certain embodiments of the method, the first biodegradable coating layer is made up of about 50 to about 95 weight percent polyhydroxyalkanoates and about 5 to about 50 weight percent of a biodegradable polymer other than polyhydroxyalkanoates.

Further, at least the first biodegradable coating layer starts to dissolve after about 3 to about 21 days exposure to environmental conditions at a temperature of about −5 to about 60° C. and a pH of about 2 to 9. More preferably, at least 10 weight percent of the first biodegradable coating layer is dissolved after about 3 to about 21 days exposure to environmental conditions at a temperature of about 60 to about 100° F. (about 16 to about 38° C.).

In certain embodiments of the method, the granular composition may also include a second biodegradable coating layer applied over the first biodegradable coating layer. This second biodegradable coating layer is preferably made up of at least polymer selected from the group consisting of polycaprolactone, polylactic acid, polybutylene succinate, polybutylene succinate-co-adipate, mesolactide, polybutylene adipate-co-terephthalate, polyvinyl alcohol, polyvinyl acetate, cellulose esters, polysaccharides, polybutylene adipate co butylene terephthalate, polyglycolic acid, polymaleic acid, and mixtures thereof.

### DETAILED DESCRIPTION

Granular Composition

According to the present disclosure, a granular composition for agricultural use is provided. This granular composition is made up of a plurality of granulates having at least a first biodegradable coating applied over the granulates.

The granulates may be made up of various materials agriculturally useful materials. In general, the granulates may be made up of a material selected from the group consisting of seeds, fertilizers, and pesticides. In some instances, the granulates of the composition are preferably made up of seeds. Examples of seeds which may be used in the granular composition include grass seeds, fruit and nut tree seeds, crop seeds, and vegetable plant seeds.

In other embodiments, the granulates of the composition are preferably made up of fertilizer. Fertilizers which may be provided as a coated granular composition according to the present disclosure include nitrogen, phosphorous, and potassium-based fertilizers. In a particularly preferred example, the fertilizer may be a urea-based fertilizer.

In still other instances, the granulates may be made up of a pesticide. In general, any solid pesticide material may be provided as a coated granular composition according to the present disclosure, including inorganic pesticides, organic pesticides, and biopesticides. Examples of such pesticides including but not limited to pesticides containing ammonium nitrate, potassium chloride, sodium phosphate, calcium sulfate, chlorpyrifos, metribuzin, chlorimuron ethyl, atrazine, S-metolachlor, cyanazine, viral-based biopesticides, and bacterial-based biopesticides.

The size of the granulates will vary depending upon the nature of the granulate material. In general, the granulates will have an average particle size, before coating, from about 1 to about 25 mm. More particularly, for seeds, the granulates may preferably have an average particle size, before coating, from about 1 to about 25 mm. For fertilizers, the granulates may preferably have an average particle size, before coating, from about 1 to about 8.5 mm. For pesticides, the granulates may preferably have an average particle size, before coating, from about 1 to about 10 mm.

According to the present disclosure, at least a first biodegradable coating which includes polyhydroxyalkanoates (PHAs) is applied over the granulates. These polyhydroxyalkanoates include from about 70 to about 99 mole percent monomer residues of hydroxybutyrates and from about 1 to about 30 mole percent monomer residues of a different hydroxyalkanoate having from 5 to 22 carbon atoms.

In more preferred embodiments, the polyhydroxyalkanoates are preferably made up of from about 70 to about 99 mole percent monomer residues of 3-hydroxybutyrate. Also, in some instances, the polyhydroxyalkanoates are preferably made up of from about 1 to about 30 mole percent monomer residues of 3-hydroxyhexanoate.

In some embodiments of the method, the polyhydroxyalkanoates may be made up of three or more different types of hydroxyalkanoate monomer residues, each having from 5 to 22 carbon atoms. For instance, the polyhydroxyalkanoates may in some instances be made up of monomer residues of 3-hydroxybutyrate, monomer residues of 3-hydroxyvalerate, and monomer residues of 3-hydroxyhexanoate.

In other instances, the polyhydroxyalkanoates may be made up of at least three different type of monomer residues selected from the group consisting of monomer residues of 3-hydroxybutyrate, monomer residues of 4-hydroxybutyrate, monomer residues of 3-hydroxyvalerate, monomer residues of 3-hydroxyhexanoate, monomer residues of 3-hydroxyoctanoate, and monomer residues of 3-hydroxydecanoate.

In certain embodiments, the first biodegradable coating preferably includes polyhydroxyalkanoates having a weight average molecular weight from about 50,000 to about 2.5 million Daltons.

In certain embodiments, the polyhydroxyalkanoates may also include monomer residues of 3-hydroxyvalerate, 4-hydroxyvalerate, and/or 5-hydroxyvalerate.

In some instances, the first biodegradable coating layer may also include one or more additional polymers. For instance, the first biodegradable coating layer may also include at least polymer selected from the group consisting of polycaprolactone, polylactic acid, polybutylene succinate, polybutylene succinate-co-adipate, mesolactide, polybutylene adipate-co-terephthalate, polyvinyl alcohol, polyvinyl acetate, cellulose esters, polysaccharides, polyglycolic acid, polymaleic acid, and mixtures thereof. In one more preferred embodiment, the first biodegradable coating layer may include from about 5 to about 95 weight percent polycaprolactone.

Moreover, in some embodiments, the granular composition may also include a second biodegradable coating layer, which is applied over the first biodegradable coating layer. This second biodegradable coating layer is preferably made up of at least polymer selected from the group consisting of polycaprolactone, polylactic acid, polybutylene succinate, polybutylene succinate-co-adipate, polyvinyl alcohol, polyvinyl acetate, cellulose esters, polysaccharides, polybutylene adipate co butylene terephthalate, polyglycolic acid, polymaleic acid, and mixtures thereof.

In some instances, the granular composition may include further coating layers, in addition to the first and second biodegradable coating layers. These optional, additional coating layers may be applied underneath the first coating layer, between the first and second coating layers, and/or on top of the second coating layer.

In certain embodiments of the method, the first biodegradable coating layer is made up of about 50 to about 95 weight percent polyhydroxyalkanoates and about 5 to about 50 weight percent of a biodegradable polymer other than polyhydroxyalkanoates. Suitable examples of compositions for the first biodegradable coating layer include:

| PHA weight | |
|---|---|
| percent | Additional biodegradable polymer weight percent |
| 70-95 wt. % | 5-30 wt. % polycaprolactone (PCL) |
| 60-95 wt. % | 5-40 wt. % polybutylene succinate-co-adipate (PBSA) |
| 50-95 wt. % | 5-50 wt. % polylactic acid (PLA) |
| 50-95 wt. % | 5-50 wt. % Mesolactide |
| 50-95 wt. % | 4-49 wt. % polybutylene succinate (PBS) & |
| | 1-10 wt. % polyvinyl acetate (PVA) |

In some embodiments, the biodegradable coating may also include relatively small amounts 0.3 to 10% by weight of other additives, such as polyvinyl acetate, clay, calcium, talc, starch, pentaerythritol, and sulfur.

As used herein, the term “biodegradable” describes a material which can be decomposed or broken down by microbes or living organisms in the soil. In general, it is preferred that at least about 50 weight percent of the coating be made up of materials which are biodegradable. More preferably, 100 percent of the materials which make up the coating are biodegradable.

It is also preferred that the biodegradable coating includes no more than about 1.0 weight percent of polyurethane. More preferably, the biodegradable coating includes no polyurethane at all.

Preparation of the Granular Composition

In another aspect, the present disclosure provides a method for making a coated granular composition. In one embodiment, the method includes a step of mixing polyhydroxyalkanoates, and optionally other polymers and/or a solvent, at a temperature from about 25° C. to about 170° C. to provide a first coating mixture. This first coating mixture is then applied over outer surfaces of a plurality of granulates. The method also includes a step of solidifying the coating mixture to create a first biodegradable coating over the outer surfaces of the plurality of granulates. The granulates coated according to the method made up of a material selected from the group consisting of seeds, fertilizers, and pesticides.

Optionally, a second coating mixture may be prepared in a similar manner and applied over the first biodegradable coating to provide a second biodegradable coating. Moreover, any other optional layers may also be applied in the same manner.

In certain embodiments of the method, the granulates of the composition are preferably made up of seeds. In other embodiments of the method, the granulates of the compositions are preferably made up of fertilizer, more preferably a urea-based fertilizer.

Usage of the Granular Composition

The coated granular compositions of the present disclosure are suitable used for agricultural purposes. In particular, the granular compositions of the present disclosure may be used to provide a method for controlled release of the granular material.

According to this method, the coated granular composition is provided as discussed above. Again, the granulates may be made up of a material selected from the group consisting of seeds, fertilizers, and pesticides.

This granular composition is dispersed over a plot of soil being treated with the composition. The application rate may vary depending upon the nature of the granulates being applied. For a coated fertilizer granulate, the granular composition may be dispersed over a soil at a rate of about 10 to about 50 pounds per acre. For a coated pesticide granulate, the granular composition may be dispersed over a soil at a rate of about 1 to about 10 pounds per acre.

Once dispersed over the soil, the soil plot is exposed to moisture in the form of rain, irrigation, and/or ambient water vapor. Consequently, the coated granulates of the granular composition are likewise exposed to moisture.

This exposure to moisture, as well as to naturally occurring microbes in the environment, causes at least the polyhydroxyalkanoates in the biodegradable coating to begin to undergo decomposition by hydrolysis. Thus, at least the polyhydroxyalkanoates gradually dissolve into smaller oligomers and monomers. In some instances, other polymer present in the biodegradable coating may also degrade due to hydrolysis.

As this decomposition proceeds, the lower molecular weight decomposition products may be dissolved in water or otherwise leached away from the granulates, thereby creating gaps in the biodegradable coating and exposing a portion of the granulate material underneath the coating. This exposed portion of the granulate material may then be released into the soil through the gaps in the biodegradable coating.

Since the granulate is released through the gaps or openings in the coating, it follows that the rate of release of the granulate material is largely determined by the rate of decomposition of the polyhydroxyalkanoates when exposed to environmental moisture. In turn, the rate of decomposition may be affected by factors such as the specific polyhydroxyalkanoates used in the coating (such as monomer residues of 3-hydroxybutyrates, monomer residues of 4-hydroxybutyrates, monomer residues of 3-hydroxyhexanoates, and so forth up to hydroxyalkanoates having up to 22 carbon atoms) and the weight average molecular weight of the polyhydroxyalkanoates.

Advantageously then, those of skill in the art may effectively control the rate of release of the granulate material (seed, fertilizer, pesticide, etc.) by selection of an appropriate type and amount of polyhydroxyalkanoates for the biodegradable coating.

In certain embodiments of the method, at least the first biodegradable coating layer starts to dissolve after about 3 to about 21 days exposure to environmental conditions at a temperature of about −5 to about 60° C. and a pH of about 2 to 9. More preferably, at least 10 weight percent of the first biodegradable coating layer is dissolved after about 3 to about 21 days exposure to environmental conditions at a temperature of about 60 to about 100° F. (about 16 to about 38° C.).

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A granular composition for agricultural use comprising:
a plurality of granulates having at least a first biodegradable coating layer applied over the granulates,
wherein the granulates comprise a material selected from the group consisting of seeds, fertilizers, and pesticides, and wherein the polyhydroxyalkanoates comprising from about 70 to about 99 mole percent monomer residues of hydroxybutyrates and from about 1 to about 30 mole percent monomer residues of a different hydroxyalkanoate having from 5 to 22 carbon atoms.

2. The granular composition of claim 1, wherein the polyhydroxyalkanoates comprise from about 70 to about 99 mole percent monomer residues of 3-hydroxybutyrate.

3. The granular composition of claim 1, wherein the polyhydroxyalkanoates comprise from about 1 to about 30 mole percent monomer residues of 3-hydroxyhexanoate.

4. The granular composition of claim 1, wherein the granulates comprise seeds.

5. The granular composition of claim 1, wherein the granulates comprise fertilizer.

6. The granular composition of claim 1, wherein the granulates comprise pesticide.

7. The granular composition of claim 1, wherein the first biodegradable coating layer comprises polyhydroxyalkanoates having a weight average molecular weight from about 50,000 to about 2.5 million Daltons.

8. The granular composition of claim 1, wherein the polyhydroxyalkanoates further comprise monomer residues of 3-hydroxyvalerate, 4-hydroxyvalerate, and/or 5-hydroxyvalerate.

9. The granular composition of claim 1, wherein the polyhydroxyalkanoates comprise three or more different types of hydroxyalkanoate monomer residues, each having from 5 to 22 carbon atoms.

10. The granular composition of claim 1, wherein the granulates have an average particle size, before coating, from about 1 mm to about 25 mm.

11. The granular composition of claim 1, wherein the first biodegradable coating layer further comprises at least polymer selected from the group consisting of polycaprolactone, polylactic acid, polybutylene succinate, polybutylene succinate-co-adipate, polyvinyl alcohol, polyvinyl acetate, cellulose esters, polysaccharides, polybutylene adipate co butylene terephthalate, polyglycolic acid, polymaleic acid, and mixtures thereof.

12. The granular composition of claim 1, wherein the first biodegradable coating layer further comprises from about 5 to about 95 weight percent polycaprolactone.

13. The granular composition of claim 1, wherein the first biodegradable coating layer comprises less than one weight percent polyurethane.

14. The granular composition of claim 1, wherein the first biodegradable coating layer comprises about 50 to about 95 weight percent polyhydroxyalkanoates and about 5 to about 50 weight percent of a biodegradable polymer other than polyhydroxyalkanoates and wherein at least the first biodegradable coating layer starts to dissolve after about 3 to about 21 days exposure to environmental conditions at a temp of −5 to 60° C. and a pH of about 2 to 9.

15. The granular composition of claim 1, further comprising a second biodegradable coating layer applied over the first biodegradable coating layer, wherein the second biodegradable coating layer comprises at least polymer selected from the group consisting of polycaprolactone, polylactic acid, polybutylene succinate, polybutylene succinate-co-adipate, mesolactide, polybutylene adipate-co-terephthalate, polyvinyl alcohol, polyvinyl acetate, cellulose esters, polysaccharides, polyglycolic acid, polymaleic acid and mixtures thereof.

16. A method for controlled release of a granular material, comprising the steps of:
providing a granular composition comprising a plurality of granulates having a first biodegradable coating layer applied over the granulates, wherein the granulates comprise a material selected from the group consisting of seeds, fertilizers, and pesticides, and wherein the first biodegradable coating layer comprises polyhydroxyalkanoates, the polyhydroxyalkanoates comprising from about 70 to about 99 mole percent monomer residues of hydroxybutyrates and from about 1 to about 30 mole percent monomer residues of a different hydroxyalkanoate having from 5 to 22 carbon atoms;
dispersing the granular composition over a plot of soil;
dissolving at least the polyhydroxyalkanoates in the first biodegradable coating layer by exposing the plot of soil, and the granular composition dispersed therein, to moisture,
wherein dissolution of the polyhydroxyalkanoates releases the granulate into the soil.

17. The method of claim 12, wherein the polyhydroxyalkanoates comprise from about 70 to about 99 mole percent monomer residues of 3-hydroxybutyrate.

18. The method of claim 12, wherein the polyhydroxyalkanoates comprise from about 1 to about 30 mole percent monomer residues of 3-hydroxyhexanoate

19. The method of claim 12, wherein the granulates comprise seeds.

20. The method of claim 12, wherein the granulates comprise fertilizer.

21. The method of claim 12, wherein the granulates comprise pesticide.

22. The method of claim 12, wherein the polyhydroxyalkanoates further comprise monomer residues of 3-hydroxyvalerate, 4-hydroxyvalerate, and/or 5-hydroxyvalerate.

23. The granular composition of claim 1, wherein the polyhydroxyalkanoates comprise three or more different types of hydroxyalkanoate monomer residues, each having from 5 to 22 carbon atoms.

24. The method of claim 12, wherein the first biodegradable coating layer further comprises at least polymer selected from the group consisting of polycaprolactone, polylactic acid, polybutylene succinate, polybutylene succinate-co-adipate, polyvinyl alcohol, polyvinyl acetate, cellulose esters, polysaccharides, polybutylene adipate co butylene terephthalate, polyglycolic acid, polymaleic acid and mixtures thereof.

25. The method of claim 12, wherein the first biodegradable coating layer further comprises from about 5 to about 95 weight percent polycaprolactone.

26. The method of claim 12, wherein the first biodegradable coating layer comprises less than one weight percent polyurethane.

27. The method of claim 12, wherein the first biodegradable coating layer comprises about 50 to about 95 weight percent polyhydroxyalkanoates and about 5 to about 50 weight percent of a biodegradable polymer other than polyhydroxyalkanoates and wherein at least the first biodegradable coating layer starts to dissolve after about 3 to about 21 days exposure to environmental conditions at a temp of −5 to 60° C. and a pH of about 2 to 9.

28. The method of claim 12, wherein the granular composition further comprises a second biodegradable coating layer applied over the first biodegradable coating layer, wherein the second biodegradable coating layer comprises at least polymer selected from the group consisting of polycaprolactone, polylactic acid, polybutylene succinate, polybutylene succinate-co-adipate, mesolactide, polybutylene adipate-co-terephthalate, polyvinyl alcohol, polyvinyl acetate, cellulose esters, polysaccharides, polyglycolic acid, polymaleic acid and mixtures thereof.
